(19) United States
(12) Patent Application Publication
(10) Pub. No.: US 2006/0071896 A1
(43) Pub. Date: Apr. 6, 2006

(54) Method of supplying power to scan line driving circuit, and power supply circuit

(76) Inventors: Kenichi Nakata, Ukyo-Ku (JP); Hiroki Takeuchi, Ukyo-Ku (JP); Mikiya Doi, Ukyo-Ku (JP)

Correspondence Address: CANTOR COLBURN, LLP, 55 GRIFFIN ROAD SOUTH, BLOOMFIELD, CT, 06002, US

(21) Appl. No.: 11/226,177

(22) Filed: Sep. 14, 2005

(30) Foreign Application Priority Data
Oct. 1, 2004 (JP) 2004-289959
Jun. 21, 2005 (JP) 2005-181238

(51) Int. Cl. G09G 3/36

(52) U.S. Cl. 345/94

(57) ABSTRACT

A power supply circuit comprising a charge pump circuit supplies a supply voltage to a gate driver. A timing controller supplies a predetermined timing signal to a NAND circuit, a shutdown terminal of the charge pump circuit, and a gate shading circuit including a capacitor, a resistor, a NOT circuit, and a transistor. When this timing signal is high, the charge pump circuit makes a normal operation and the gate shading circuit is deactivated. When this timing signal is low, the charge pump circuit stops operating and the gate shading circuit is activated to drain an electric charge from the output of the charge pump circuit.

### BACKGROUND OF THE INVENTION

1. Field of the Invention

The present invention relates to a power supply method for supplying power to a scan line driving circuit of a liquid crystal panel or the like which has scan lines and data lines arranged in a matrix, and a power supply circuit, a display unit, and a portable apparatus.

2. Description of the Related Art

TFT (Thin Film Transistor) liquid crystal panels and the like of active matrix type have become prevalent recently, and have also grown in size year by year. The greater a panel is, the higher the parasitic impedances of its scan lines become. This can cause a timing delay of pulsed scan signals between both sides of the panel, for example. Such a timing delay contributes to panel flickering.

Japanese Patent Laid-Open Publication No. 2000-221474 describes a buffer circuit whose supply voltage can be controlled from exterior, the buffer circuit being intended for a gate pulse signal to be applied to the gate electrodes of switching transistors for pixel electrodes. Then, during an ON period for writing video signals to the pixel electrodes, the supply voltage applied to this buffer circuit is controlled into sine waves. This consequently achieves the control that the rising and falling waveforms of the gate pulse signal to be applied to the gate electrodes of the switching transistors are smoothened.

As disclosed in FIG. 1 of Japanese Patent Laid-Open Publication No. 2000-221474, however, this buffer circuit is configured separately from a circuit for generating power to be supplied to a vertical scanning driver. This requires another power supply intended for the buffer circuit, and thus increases the electric power consumption for that control.

### SUMMARY OF THE INVENTION

The present invention has been achieved in view of the foregoing circumstances. The present invention provides a power supply method, a power supply circuit, a display unit, and a portable apparatus which are capable of reducing display panel flickering while suppressing the electric power consumption.

An embodiment of the present invention provides a power supply method for supplying a supply voltage to a scan line driving circuit which generates a signal for driving a switching device connected to a scan line of a display panel, wherein a waveform of the supply voltage may be rounded in response to an ON period of the switching device. According to this embodiment, it is possible to reduce flickering of the display panel while suppressing the electric power consumption.

In an embodiment of the present invention, power supply circuit is one for supplying a supply voltage to a scan line driving circuit for generating a signal for driving a switching device connected to a scan line of a display panel. The power supply circuit may comprise: a voltage generating circuit which generates a predetermined supply voltage; and a circuit which drains a predetermined charge from an output of the voltage generating circuit so that a waveform of the supply voltage is rounded in response to an ON period of the switching device. The “voltage generating circuit” may be a charge pump circuit. The power supply circuit may be integrated on a single semiconductor substrate. According to this embodiment, it is possible to reduce flickering of the display panel while suppressing the electric power consumption.

The voltage generating circuit may stop generating the supply voltage in response to the current-draining period. According to this embodiment, it is possible to suppress the electric power consumption of the voltage generating circuit during the current-draining period. The operation timing of the voltage generating circuit and the operation timing of the circuit which drains the charge may be controlled by a timing signal generated by an identical timing controller. According to this embodiment, it is possible to suppress the electric power consumption of the voltage generating circuit during the current-draining period. The circuit configuration can also be simplified.

The power supply circuit may further comprise a circuit which adjusts the period for draining the charge. According to this embodiment, the output waveform can be shaped without being limited by any timing signal supplied from exterior. The power supply circuit may further comprise a delay circuit which delays a timing signal generated by a timing controller which controls the scan line driving circuit. The operation timing of the voltage generating circuit and the operation timing of the circuit which drains the charge may be controlled by the timing signal delayed by the delay circuit. According to this embodiment, the output waveform can be shaped without being limited by the timing signal supplied from the timing controller.

In another embodiment of the present invention, a display unit may comprise: a display panel; a scan line driving circuit which generates a signal for driving a switching device connected to a scan line of the display panel; and the power supply circuit according to any of the foregoing aspects.

According to this embodiment, it is possible to achieve a display unit which reduces flickering of the display panel while suppressing the electric power consumption.

In another embodiment of the present invention, a display unit may comprise: a display panel; a scan line driving circuit which generates a signal for driving a switching device connected to a scan line of the display panel; and the power supply circuit according to any of the foregoing aspects. Here, the power supply circuit is powered by a direct-current power source implemented thereon. The “direct-current power source implemented thereon” may be a battery cell.

According to this embodiment, it is possible to achieve a portable apparatus which reduces flickering of the display panel while suppressing the electric power consumption.

It is to be noted that any arbitrary combination or rearrangement of the above-described structural components and so forth are all effective as and encompassed by the present embodiments.

Moreover, this summary of the invention does not necessarily describe all necessary features so that the invention may also be sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a schematic diagram showing a display unit to which the power supply circuit according to an embodiment is applied;

FIG. 2 is a diagram showing the configuration of the power supply circuit according to embodiment 1;

FIG. 3A is a chart showing the waveform of a timing signal supplied from a timing controller according to embodiment 1;

FIG. 3B is a chart showing the output waveform of the power supply circuit according to embodiment 1;

FIG. 4 is a chart showing the output waveform of a gate driver;

FIG. 5 is a diagram showing the configuration of the power supply circuit according to embodiment 2;

FIG. 6A is a chart showing the waveform of the timing signal supplied from the timing controller according to embodiment 2;

FIG. 6B is a chart showing the waveform of the voltage across a third capacitor according to embodiment 2;

FIG. 6C is a chart showing and the output waveform of the power supply circuit according to embodiment 2; and

FIG. 7 is a diagram showing the configuration of a portable apparatus according to embodiment 3.

### DETAILED DESCRIPTION OF THE INVENTION

The invention will now be described based on the preferred embodiments. This does not intend to limit the scope of the present invention, but exemplify the invention.

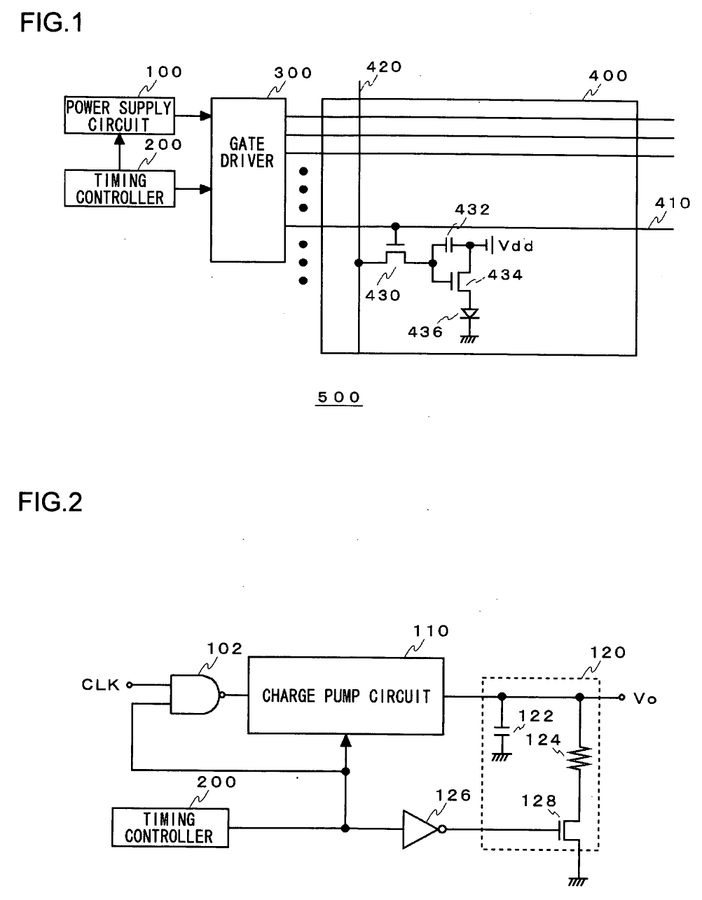

Before the detailed description of a power supply circuit 100 according to an embodiment of the present invention, a display unit 500 for the circuit to be applied to will initially be described as far as the present invention is concerned. FIG. 1 is a schematic diagram showing the display unit 500 to which the power supply circuit 100 according to the embodiment is applied. The power supply circuit 100 and a timing controller 200 will be detailed later.

A display panel 400 may be a liquid crystal panel, an organic EL panel, or the like. The display panel 400 contains a plurality of pixels. The pixels in the display panel 400 are controlled by scan lines 410 and data lines 420 which are arranged in a matrix. FIG. 1 shows a pixel circuit for controlling one of the pixels in the display panel 400.

This pixel circuit comprises: two n-channel transistors, or a first transistor 430 and a second transistor 434; an optical device 436 such as an organic EL device; a first capacitor 432; a scan line 410, a power supply Vdd; and a data line 420 for inputting brightness data. It is understood that the optical device 436 may be a liquid crystal cell.

The operation of this pixel circuit will now be described. In order to write brightness data to the optical device 436, the scan line 410 becomes high to turn on the first transistor 430. The brightness data input to the data line 420 is set into the second transistor 434 and the first capacitor 432. At the timing of light emission, the scan line 410 becomes low to turn off the first transistor 430, so that the gate voltage of the second transistor 434 is maintained for the sake of light emission with the set brightness data. While the display panel described in FIG. 1 is of active matrix type, one of passive matrix drive is also applicable.

As described above, the light emission of each individual pixel is controlled by controlling on/off the gate of the first transistor 430. A gate driver 300 applies a pulsed control signal for controlling on/off the gate of the first transistor 430 to the scan line 410. That is, the gate driver 300 functions as a scan line driving circuit for driving the scan lines.

(Embodiment 1)

FIG. 2 is a diagram showing the configuration of the power supply circuit 100 according to embodiment 1. The power supply circuit 100 has a charge pump circuit 110. The charge pump circuit 110 is a circuit for boosting a not-shown supply voltage to output a certain level of voltage. In the present embodiment, it outputs a constant voltage of around 30 V, for example. The charge pump circuit 110 contains a plurality of not-shown capacitors and a switch for switching on/off the charging of these capacitors. In general, the charge pump circuit can boost the input voltage by controlling the charging and discharging timing of the individual capacitors. The ON/OFF timing of this switch is controlled by a timing signal to be described later.

A second capacitor 122, a resistor 124, and a third transistor 128 constitute a circuit for draining an electric charge from the output of the charge pump circuit 110 at predetermined timing (hereinafter, referred to as gate shading circuit 120). The second capacitor 122 charges the output of the charge pump circuit 110. A NOT circuit 126 inverts the logic of the timing signal to be described later. The third transistor 128 is an n-channel transistor, which turns on and off when the output of the NOT circuit 126 is high and low, respectively. Incidentally, the third transistor 128 may be any device as long as it has a switching function. The resistor 124 is intended to drain the charge of the second capacitor 122 into the ground when the third transistor 128 turns on.

A NAND circuit 102 is connected in the prior stage of the is charge pump circuit 110. A predetermined clock signal CLK is always input to one of the input terminals of the NAND circuit 102. This clock signal CLK is intended to supply the timing for boosting the foregoing supply voltage inside the charge pump circuit 110. The other input terminal of the NAND circuit 102 receives the timing signal from the timing controller 200.

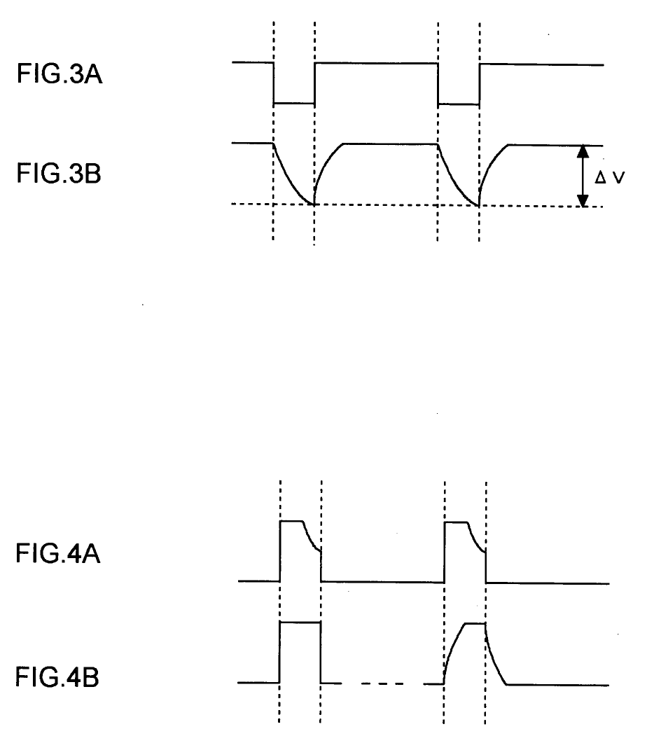

FIG. 3 is a chart showing the waveform of the timing signal supplied from the timing controller 200, and the output waveform of the power supply circuit 100 according to embodiment 1. The timing controller 200 generates pulses as shown in FIG. 3(a), and inputs them to the NAND circuit 102, a shutdown terminal of the charge pump circuit 110, and the gate shading circuit 120. As a result, a voltage having a waveform shaped as shown in FIG. 3(b) is output from the power supply circuit 100.

Suppose, for example, that the display panel 400 has 760 scan lines and displays 60 frames per second. Then, approximately 20 μs can be allocated for each single scan line 410. In this case, a low period of 5 μs or so is provided to round the output waveform of the power supply circuit 100. These values of duration are given solely by way of example, and may be set and changed as appropriate depending on such factors as the specifications of the display panel 400.

The NAND circuit 102 outputs a signal having the inverted logic of the foregoing clock signal CLK when the timing signal is high. Here, the charge pump circuit 110 boosts the supply voltage by using this inverted clock signal CLK. On the other hand, when the timing signal is low, the NAND circuit 102 outputs high all the time regardless of the clock signal CLK. In this case, the charge pump circuit 110 cannot perform boosting since no timing is supplied thereto.

The charge pump circuit 110 is configured so that it can control the switching of the capacitance at the final stage inside by using its own output voltage. Here, given that an integrating circuit made of an operational amplifier is provided so that the switching control is effected by using the output voltage of the integrating circuit, the shutdown terminal can be connected to the power supply of this operational amplifier. According to this configuration, the operational amplifier is powered for a normal operation when the timing signal is high. On the other hand, when the timing signal is low, the operational amplifier is no longer powered. The switch is thus turned off, thereby making it impossible to charge the capacitance at the final stage. Consequently, the charge pump circuit 110 stops operating, and thus quits charging the second capacitance 122.

When the timing signal is high, the gate shading circuit 120 makes no operation since the third transistor 128 is off. On the other hand, when the timing signal is low, the third transistor 128 turns on so that the charge can be drained from the output of the charge pump circuit 110.

The output waveform of the power supply circuit 100 is adjusted depending on the specifications of the gate driver 300, the display panel 400, etc. This adjustment can be effected by modifying the amount of charge to be drained. Then, the amount of charge to be drained can be determined by adjusting any one of the capacitance of the second capacitor 122, the resistance of the resistor 124, and the size of the third transistor 128, or a combination of these.

In summary, when the timing signal is high, the output of the charge pump circuit 110 appears directly on the output of the power supply circuit 100. When the timing signal is low, the output of the charge pump circuit 110 is drained into a rounded waveform. For example, with the timing signal of FIG. 3(a), the output of the power supply circuit 100 exhibits such a waveform as shown in FIG. 3(b). The difference ΔV between the high and low potentials of FIG. 3(b) can be created arbitrarily by means of the capacitance of the second capacitor 122 and the resistance of the resister 124.

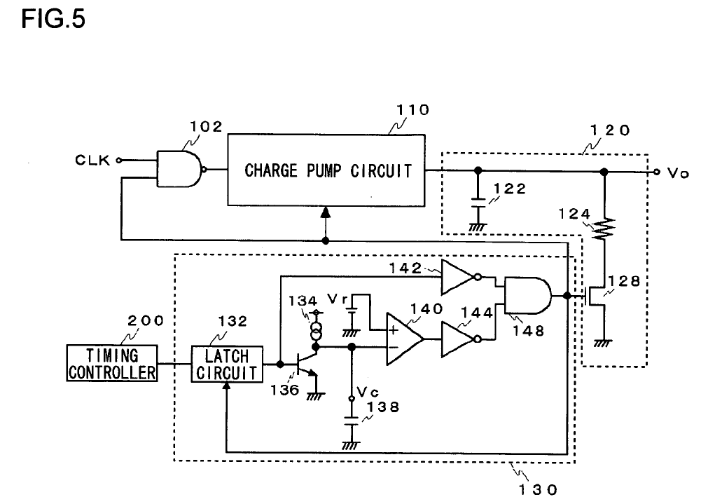

The output of this power supply circuit 100 makes the supply voltage for the gate driver 300 shown in FIG. 1. FIG. 4 is a chart showing the output waveform of the gate driver 300. The gate driver 300 generates a control signal for driving the first transistor 430, from the supply voltage and the timing signal. FIG. 4(a) shows the waveform of the control circuit in the present embodiment. Since the supply voltage is rounded, the control signal is also rounded at the falling edges from high to low.

FIG. 4(b) shows a control signal that is generated from an ordinary, not-rounded supply voltage and the timing signal. In FIG. 4(b), the left waveform represents the signal to appear at a point near the gate driver, and the right waveform the signal at a point far from the gate driver. The display panel 400 of FIG. 1 switches the scan lines at the timing of the falling edges. Thus, when the signal has not the rounded falling edges at points far from the gate driver and the not-rounded falling edges at near points as in FIG. 4(b), the driving timing of the first transistors 430 may varies depending on the distance from the gate driver. In contrast, in FIG. 4(a), the control signal is generated from the supply voltage that is rounded in advance. The falling edges thus appear at uniform timing regardless of the distance from the gate driver.

As has been described, according to embodiment 1, the gate driver is supplied with the output of the power supply circuit which is rounded so that the control signal applied to the scan lines exhibits rounded high periods. This makes it possible to reduce variations in the timing of selection of pixels on each identical scan line, thereby reducing flickering of the display panel.

Moreover, during the period in which the supply voltage is rounded, the constant voltage generating circuit constituting the power supply circuit, such as the charge pump circuit, can be deactivated to suppress the electric power consumption. In the foregoing example of FIG. 3, the operation of the charge pump circuit is stopped for 5 μs in each single cycle of 20 μs. This can suppress the electric power consumption to ¾ as compared to the case where the circuit is not stopped.

(Embodiment 2)

FIG. 5 is a diagram showing the configuration of the power supply circuit 100 according to embodiment 2. Embodiment 2 provides the configuration that a delay circuit 130 is added to the power supply circuit 100 according to embodiment 1. The same components as in embodiment 1 will be designated by identical reference numerals. The following description will thus deal with the configuration and operation different from in embodiment 1.

The delay circuit 130 comprises a latch circuit 132, a constant current source 134, a fourth transistor 136, a third capacitor 138, a comparator 140, a second NOT circuit 142, a third NOT circuit 144, and an AND circuit 146.

The latch circuit 132 has a set terminal which receives the timing signal supplied from the timing controller 200, and a reset terminal which receives the output of the AND circuit 146. The latch circuit 132 outputs high when the timing signal is high. Then, the second NOT circuit 142 outputs low, which is input to one of the terminals of the AND circuit 146. As a result, the AND circuit 146 outputs low, which is input to the NAND circuit 102, the shutdown terminal of the charge pump circuit 110, the gate of the third transistor, and the latch circuit 132. Consequently, the charge pump circuit 110 maintains its normal operation, and the gate shading circuit 120 will not drain the charge.

Next, when the timing signal changes to low, the latch circuit 132 outputs low. The second NOT circuit 142 then outputs high, which is input to the one terminal of the AND circuit 146. It follows that the output of the AND circuit 146 depends on the input to the other terminal.

The low output of the latch circuit 132 turns off the base of the fourth transistor 136. As a result, the output of the constant current source 134 will not pass through the fourth transistor 136 but appears on the collector. The third capacitor 138 is thus charged with the voltage. The voltage Vc across this third capacitor 138 is input to the inverting input terminal of the comparator 140.

The noninverting input terminal of the comparator 140 receives a predetermined reference voltage Vr. The value of this reference voltage, the current I of the constant current source 134, and the capacitance C of the third capacitor 138 can be used to set a delay time Δt to be described later. More specifically, Δt=Vr·C/I.

The comparator 140 outputs high when the voltage Vc across the third capacitor 138 exceeds the predetermined reference voltage Vr, and outputs low when not. After the fourth transistor 136 turns off, the comparator 140 outputs low during the delay time Δt. This makes the output of the third NOT circuit high, and all the input terminals of the AND circuit 146 high. The AND circuit 146 thus outputs high to the NAND circuit 102, the shutdown terminal of the charge pump circuit 110, the gate of the third transistor, and the latch circuit 132.

Consequently, the charge pump circuit 110 stops operating, and the gate shading circuit 120 drains the charge from the output of the charge pump circuit 110. In this embodiment, the latch circuit 132 holds the input of the set terminal when the reset terminal is high. Here, the set terminal is held at low even when the timing signal changes to high.

After a lapse of the delay time Δt since the fourth transistor 136 turns off, the comparator 140 changes to high. This makes the output of the third NOT circuit low, and one of the input terminals of the AND circuit 146 low. The AND circuit 146 thus outputs low to the NAND circuit 102, the shutdown terminal of the charge pump circuit 110, the gate of the third transistor, and the latch circuit 132. Consequently, the charge pump circuit 110 returns to its normal operation, and the gate shading circuit 120 stops draining the charge. The latch circuit 132 resets the value of the set terminal when the reset terminal is low. Thus, the latch circuit 132 outputs high if the set terminal is receiving high in this stage.

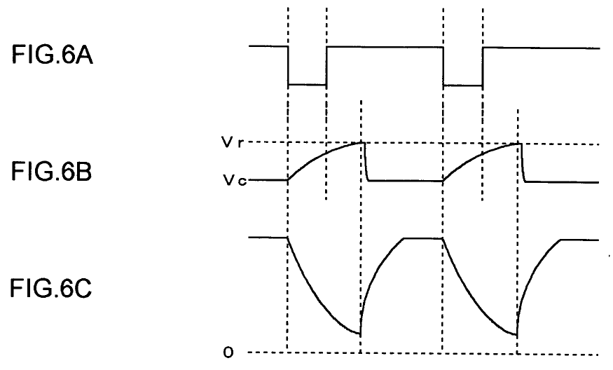

FIG. 6 is a chart showing the waveform of the timing signal supplied from the timing controller 200, the waveform of the voltage Vc across the third capacitor 138, and the output waveform of the power supply circuit 100 according to embodiment 2. Like FIG. 3(a), FIG. 6(a) shows a pulsed signal generated by the timing controller 200. In FIG. 6(b), the voltage across the third capacitor 138 is integrated up to the reference voltage Vr of the comparator 140. The period for reaching this reference voltage Vr is the delay time Δt mentioned above. FIG. 6(c) shows the output waveform of the power supply circuit 100 according to embodiment 2. As can be seen from a comparison with the output waveform of embodiment 1 shown in FIG. 3(b), the period for rounding the waveform can be set without being limited by the pulse width of the timing signal. More specifically, due to the formation of the rounding corresponding to the delay time Δt, any waveform can be created by adjusting such parameters as the value of the reference voltage Vr, the current I of the constant current source 134, and the capacitance C of the third capacitor 138.

As has been described, according to embodiment 2, the output waveform of the power supply circuit can be rounded without being limited by the timing of supply of the timing controller. Consequently, when the timing signal is used by other circuits such as the gate driver, it is possible to adjust the output waveform without any effect on those circuits. This facilitates circuit design.

(Embodiment 3)

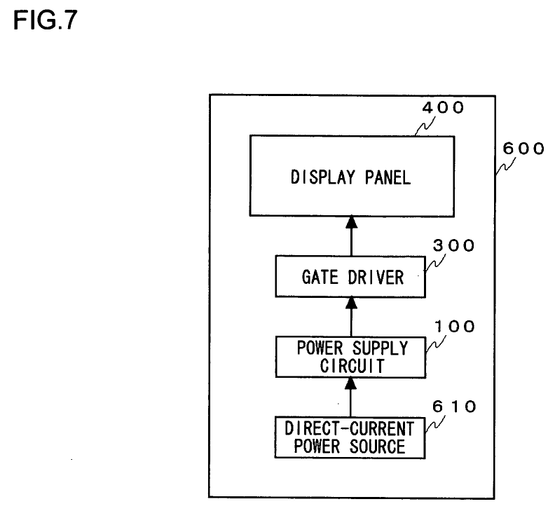

FIG. 7 is a block diagram showing the configuration of a portable apparatus 600 according to embodiment 3. This portable apparatus 600 corresponds to one that implements a display device, including a cellular phone, a PHS (Personal Handyphone System), a PDA (Personal Digital Assistance), a digital camera, and a music player. The portable apparatus 600 comprises: a display panel 400 for displaying predetermined images; a gate driver 300 for controlling scan lines of the same; the power supply circuit according to embodiment 1 or 2 for supplying power thereto; and a direct-current power source 610 for supplying power to the power supply circuit 100. The examples of the direct-current power source 610 include a lithium ion battery cell and a rechargeable battery.

As has been described, according to embodiment 3, the implementation of the power supply circuit 100 according to embodiment 1 or 2 makes it possible to achieve a portable apparatus which can reduce flickering of the display panel while suppressing the electric power consumption. Consequently, it is possible to achieve both the extended operating time of the portable apparatus and the improved quality of images displayed on the display unit.

Up to this point, the present invention has been described in conjunction with the embodiments thereof. These embodiments have been given solely by way of illustration. It will be understood by those skilled in the art that various modifications may be made to combinations of the foregoing components and processes, and all such modifications are also intended to fall within the scope of the present invention.

The embodiments have dealt with the cases where a charge pump circuit is used to generate the stabilized supply voltage. Instead, a switching regulator or an ordinary regulator may be used. In this case, a somewhat high supply voltage must be input thereto.

In the embodiments, the charge is drained by means of a resistor. Instead, a constant current source may be used for draining.

Moreover, while the embodiments have dealt with the cases of rounding the falling edges, it is also possible to round the rising edges of the signal to be applied to the scan lines. Both the edges may also be rounded. The supply voltages having such waveforms can be achieved easily by typical waveform shaping technologies.

While the preferred embodiments of the present invention have been described using specific terms, such description is for illustrative purposes only, and it is to be understood that changes and variations may be made without departing from the spirit or scope of the appended claims.

What is claimed is:

1. A power supply method for supplying a supply voltage to a scan line driving circuit which generates a signal for driving a switching device connected to a scan line of a display panel, wherein
a waveform of the supply voltage is rounded in response to an ON period of the switching device.

2. A power supply circuit for supplying a supply voltage to a scan line driving circuit for generating a signal for driving a switching device connected to a scan line of a display panel, the power supply circuit comprising:
a voltage generating circuit which generates a predetermined supply voltage; and
a circuit which drains a predetermined charge from an output of the voltage generating circuit so that a waveform of the supply voltage is rounded in response to an ON period of the switching device.

3. The power supply circuit according to claim 2, wherein the voltage generating circuit stops generating the supply voltage in response to the current-draining period.

4. The power supply circuit according to claim 2, wherein the operation timing of the voltage generating circuit and the operation timing of the circuit which drains the charge are controlled by a timing signal generated by an identical timing controller.

5. The power supply circuit according to claim 3, wherein the operation timing of the voltage generating circuit and the operation timing of the circuit which drains the charge are controlled by a timing signal generated by an identical timing controller.

6. The power supply circuit according to claim 2, further comprising a circuit which adjusts the period for draining the charge.

7. The power supply circuit according to claim 3, further comprising a circuit which adjusts the period for draining the charge.

8. The power supply circuit according to claim 2, further comprising a delay circuit which delays a timing signal generated by a timing controller which controls the scan line driving circuit, and wherein
the operation timing of the voltage generating circuit and the operation timing of the circuit which drains the charge are controlled by the timing signal delayed by the delay circuit.

9. The power supply circuit according to claim 3, further comprising a delay circuit which delays a timing signal generated by a timing controller which controls the scan line driving circuit, and wherein
the operation timing of the voltage generating circuit and the operation timing of the circuit which drains the charge are controlled by the timing signal delayed by the delay circuit.

10. The power supply circuit according to claim 2, being integrated on a single semiconductor substrate.

11. The power supply circuit according to claim 6, being integrated on a single semiconductor substrate.

12. The power supply circuit according to claim 8, being integrated on a single semiconductor substrate.

13. A display unit comprising:
a display panel;
a scan line driving circuit which generates a signal for driving a switching device connected to a scan line of the display panel; and
the power supply circuit according to claim 2.

14. A display unit comprising:
a display panel;
a scan line driving circuit which generates a signal for driving a switching device connected to a scan line of the display panel; and
the power supply circuit according to claim 3.

15. A display unit comprising:
a display panel;
a scan line driving circuit which generates a signal for driving a switching device connected to a scan line of the display panel; and
the power supply circuit according to claim 6.

16. A display unit comprising:
a display panel;
a scan line driving circuit which generates a signal for driving a switching device connected to a scan line of the display panel; and
the power supply circuit according to claim 8.

17. A portable apparatus comprising:
a display panel;
a scan line driving circuit which generates a signal for driving a switching device connected to a scan line of the display panel; and
the power supply circuit according to claim 2, and wherein
the power supply circuit is powered by a direct-current power source implemented thereon.

18. A portable apparatus comprising:
a display panel;
a scan line driving circuit which generates a signal for driving a switching device connected to a scan line of the display panel; and
the power supply circuit according to claim 3, and wherein
the power supply circuit is powered by a direct-current power source implemented thereon.

19. A portable apparatus comprising:
a display panel;
a scan line driving circuit which generates a signal for driving a switching device connected to a scan line of the display panel; and
the power supply circuit according to claim 6, and wherein
the power supply circuit is powered by a direct-current power source implemented thereon.

20. A portable apparatus comprising:
a display panel;
a scan line driving circuit which generates a signal for driving a switching device connected to a scan line of the display panel; and
the power supply circuit according to claim 8, and wherein
the power supply circuit is powered by a direct-current power source implemented thereon.
